(19) United States
(12) Patent Application Publication
(10) Pub. No.: US 2009/0242270 A1
(43) Pub. Date: Oct. 1, 2009

(54) Wiring System for LED Signs

(76) Inventor: Roger L. Rumsey, Wichita, KS (US)

Correspondence Address: GABLE & GOTWALS, 100 WEST FIFTH STREET, 10TH FLOOR, TULSA, OK, 74103, US

(21) Appl. No.: 12/396,595

(22) Filed: Mar. 3, 2009

Related U.S. Application Data
(60) Provisional application No. 61/041,359, filed on Apr. 1, 2008.

(51) Int. Cl. H02G 3/18; H01R 9/05

(52) U.S. Cl. 174/650; 439/578

(57) ABSTRACT

A wiring system for LED signs includes a plurality of coaxial cables in circuit relationship to a power supply and at least one light emitting diode within a letter box housing. A bushing connectable to the housing has two cylindrical longitudinal passageways therethrough, each passageway dimensioned to accommodate an outside diameter of a coaxial cable. The coaxial cables may be a predetermined length and the cables and bushing may come preassembled to the job site. Additional sets of coaxial cables may be connected to the circuit in series or parallel wiring arrangement by way of a splice connector that receives and fastens the threaded fitting at the end of each coaxial cable. The bushings and the splice connector provide strain relief for the coaxial cable and a safety ground path for the circuit.

### REFERENCE TO PENDING APPLICATIONS

This application claims priority to U.S. Provisional Patent Application No. 61/041,359, filed Apr. 1, 2008, and entitled “Wiring System for LED Signs”.

### FIELD OF INVENTION

The present invention relates generally to the use of light emitting diodes (LEDs) in signage and, more particularly, to wiring systems in LED signage applications.

### BACKGROUND OF INVENTION

Channel letters are commonly used in signage to advertise the name of the business. A housing in the shape of the letter and covered by a plastic translucent lens typically contains one or more neon light tubes arranged in the shape of the letter. Although neon lighting provides a bright, continuous light source, it is also fragile, experiences difficulty in cold starting, and high voltage is required. Because of these disadvantages, the sign lighting industry has witnessed major changes over the past five years as neon lighting is being replaced by light emitting diodes (LEDs) in channel letter applications.

One of the basic assumptions driving the conversion to LEDs is that the low voltage LEDs are safer, less expensive, and more energy efficient than neon. However, a lack of knowledge concerning DC voltage transmission coupled with no adequate system for safety ground continuity, splice connections, and wiring designed for use with LEDs leaves a great many LED installations less safe, more expensive, and less energy efficient than anticipated.

To date, a myriad of products and installation methods to properly connect power sources to LEDs have been introduced. Those methods include the use of (1) insulated speaker wire or other small diameter wire, which typically lack proper conductor size and insulation not designed for such use inside and outside of a building; (2) Class 2 wires designed for interior use only; (3) the combination of insulated speaker wire or class 2 wire with mechanical conduit and make-up boxes; (4) wire splicing with wire nuts, electrical tape, and bare twisted wire connections; (5) one or more large holes drilled through the sign-supporting substraight; (6) no secondary safety ground wiring; and (7) a hodgepodge of parts and pieces left to the discretion and knowledge of the installer to make a proper connection between the power source and the LEDs. All the above leaves electrical sign inspectors and field installation crews looking for a safe, practical, and National Electric Code-compliant method and system for connecting power sources to LEDs.

### SUMMARY OF THE INVENTION

A wiring system for a light emitting diode (LED) sign includes a wiring set and a system and method for connecting the wiring set to the LED sign. The wiring set includes a bushing with at least two cylindrical longitudinal passageways that is received by an opening in a letter box housing. Each passageway receives a portion of a coaxial cable and holds that portion of the cable securely within the bushing. A chamfered opening at an end of each passageway protects the portion of each cable extending from the bushing into the interior of the housing from becoming cut or bent. Each cable has a threaded fitting at one end that allows it to be spliced by a splice assembly connector to an opposing cable of a second wiring set. In a preferred embodiment, the coaxial cables are each predetermined length “L” with at least one of the coaxial cables in each set having a marking or band that indicates a proper polarity connection with an opposing coaxial cable of a second wiring set.

A wiring system according to this invention includes two or more coaxial cables of a wiring set arranged in a circuit relationship to a power supply and at least one light emitting diode contained within a letter box housing. The power supply is preferably a 50V or less power supply. A knockout or opening in the housing receives a bushing having two substantially cylindrical longitudinal passageways. Each bushing passageway is preferably co-planar to the other passageway and sized so as to allow a portion of a coaxial cable to tightly pass therethrough. The coaxial cable may be a predetermined length of cable.

The bushing connects to the housing by way of a locknut threaded onto the bushing and tightened so that a flange portion of the bushing seats to an exterior surface of the housing, thereby providing a ground and strain relief for the two coaxial cables. A chamfered opening at an end of each passageway also protects the portion of each cable extending from the bushing into the interior of the housing from becoming cut or bent.

The wiring system may also include a coaxial cable splice connector. The splice connector may include a bushing with a receiver on each end that accommodates the threaded termination end of the coaxial cable and receives the conductive portion of the coaxial cable. A nut threads onto the termination end and secures the coaxial cable to the connector, thereby providing a strain relief as well as a ground path.

A method of wiring the LED sign includes the steps of connecting a conductive portion of a first end of a first coaxial cable to a power supply and splicing a second end of the first coaxial cable to a first end of a second coaxial cable. A portion of the second coaxial cable passes tightly through a passageway in a first bushing that is connectable to the letter box housing. A conductive portion at a second end of the second coaxial cable is connected to a LED housed within the letter box housing. The bushing is then secured to the letter box housing and a safety ground path is provided. Additional letter boxes may be connected to the circuit by splicing a first end of a third coaxial cable that passes tightly through a second passageway of the first bushing to a first end of a fourth coaxial cable that passes tightly through a passageway in a second bushing connectable to a second letter box housing.

### BRIEF DESCRIPTION OF THE DRAWINGS

FIG. 1 is an isometric view of a junction box connector assembly for a single coaxial cable. A threaded fitting located on an end of the coaxial cable threads into a bushing and is secured to the junction box by a locknut.

FIG. 2 is a reverse isometric view illustrating the relationship between the threaded fitting on the cable and the bushing.

FIG. 3 is an isometric view of the assembled connector assembly.

FIG. 4 is an isometric view of a splice assembly having a connector with a conductive bushing.

FIG. 5 is a front view of the splice assembly. Each end of the connector receives the conductive portion of a coaxial cable. A nut provided with each cable secures the cable to the connector.

FIG. 6 is a front view of the completed splice assembly. The assembly provides a path for current flowing in one cable to pass to the other cable.

FIG. 7 is an isometric view of a dual-cable letter box connector assembly.

FIG. 8 is a front view of the dual-cable letter box connector assembly. A bushing having two cylindrical passageways allows two coaxial cables to pass therethrough. A locknut threads onto the exterior threads of the bushing.

FIG. 9 is a view taken along section line 9-9 of FIG. 8.

FIG. 10 is a front view of the bushing used in the dual-cable junction box connector assembly.

FIG. 11 is a view of the bushing taken along section line 11-11 of FIG. 10.

FIG. 12 is a front view of the bushing without coaxial cable passing therethrough.

FIG. 13 is a view of a letter box having a knockout and connected to the dual-cable junction box connector assembly. The coaxial cables supply current to an array of light emitting diodes (LEDs).

FIG. 14 is a front view of a Z-shaped letter box containing LEDs arranged in a corresponding Z-shape. Coaxial cables provided by the dual-cable junction box connector assembly supply current to the LEDs.

FIG. 15 is a view of the wiring system in a series arrangement and employing the single- and dual-cable junction box connector assemblies and the splice assembly.

FIG. 16 is an alternate embodiment of the letter box connector assembly.

FIG. 17 is a view of the letter box connector assembly taken along section line 17-17 of FIG. 16. Cylindrical passageways in the bushing allow coaxial cables to pass therethrough.

FIG. 18 is an exploded view of the letter box connector assembly.

FIG. 19 is a front view of the letter box connector assembly. The bushing may have two or four cylindrical passageways for receiving coaxial cable.

FIG. 20 is a view of the letter box connector assembly configured for a parallel wiring arrangement. Four coaxial cables, each preferably 3 feet in length, pass therethrough. Two of the cables have a male connector at one end and two of the cables have a female fitting for attachment to a complementary preassembled letter box connector assembly.

FIG. 21 is a view of the letter box connector assembly taken along section line 21-21 of FIG. 20. A locknut secures the connector assembly to the letter box, thereby providing a ground path and strain relief between coaxial cable and the letter box.

FIG. 22 is a view of the wiring system connected in a parallel arrangement.

FIG. 23 is a view of the letter box connector assembly with two coaxial cables passing therethrough for use in a series wiring arrangement. Color coding is used on the coaxial cables so that the proper splice connections are made throughout the wiring system.

FIG. 24 is a view of a wiring set designed to connect to the wiring set illustrated in FIG. 23.

FIG. 25 is a view of the wiring system connected in a series arrangement.

FIG. 26 is a view of a 2-wire system connected in a split parallel wiring arrangement. The system includes one set of letter leads for each letter box, a set of jump leads to connect the sets of letter leads, and a transformer lead. All of the leads are color-coded to ensure that the proper splice connections are made throughout.

FIG. 27 is a view of the 2-wire system of FIG. 26 connected in a standard parallel wiring arrangement.

### DETAILED DESCRIPTION OF THE PREFERRED EMBODIMENTS

The invention described below is not limited in its application to the details illustrated in the accompanying drawings. The invention is capable of other embodiments and of being practiced or carried out in a variety of ways. The phraseology and terminology employed herein are for purposes of description and not limitation. Elements illustrated in the drawings are identified by the following numbers:

| | |
|---|---|
| 10 | Wiring system |
| 12 | Coaxial cable |
| 14 | Junction box |
| 16 | Letter box |
| 18 | Light emitting diode |
| 20 | Junction box connector assembly |
| 22 | Threaded fitting |
| 24 | Bushing |
| 26 | Locknut |
| 27 | Flange portion |
| 28 | Central opening |
| 29 | Threaded portion |
| 30 | Splice assembly |
| 32 | Threaded fitting |
| 34 | Splice connector |
| 36 | Nut |
| 37 | Opening |
| 38 | Insulated bushing |
| 39 | Threaded portion |
| 40 | Letter box connector assembly |
| 42 | Bushing |
| 44 | Locknut |
| 46 | First cylindrical passageway |
| 47 | Interior wall |
| 48 | Second cylindrical passageway |
| 50 | Chamfered opening |
| 62 | Threaded fitting |
| 64 | Splice connector |
| 66 | Marking |
| 68 | Band |
| 70 | Wiring set |
| 82 | Bushing |
| 84 | Fitting |
| 86 | Passageway |
| 88 | Passageway |
| 90 | Passageway |
| 92 | Passageway |
| 110 | Conductor |
| 112 | Insulator |
| 114 | Outer insulator |
| 116 | First end |
| 118 | Second end |
| 120 | Pass-thru or letter box lead |
| 122 | Jumper lead |
| 124 | Transformer lead |
| 130 | Splice assembly |

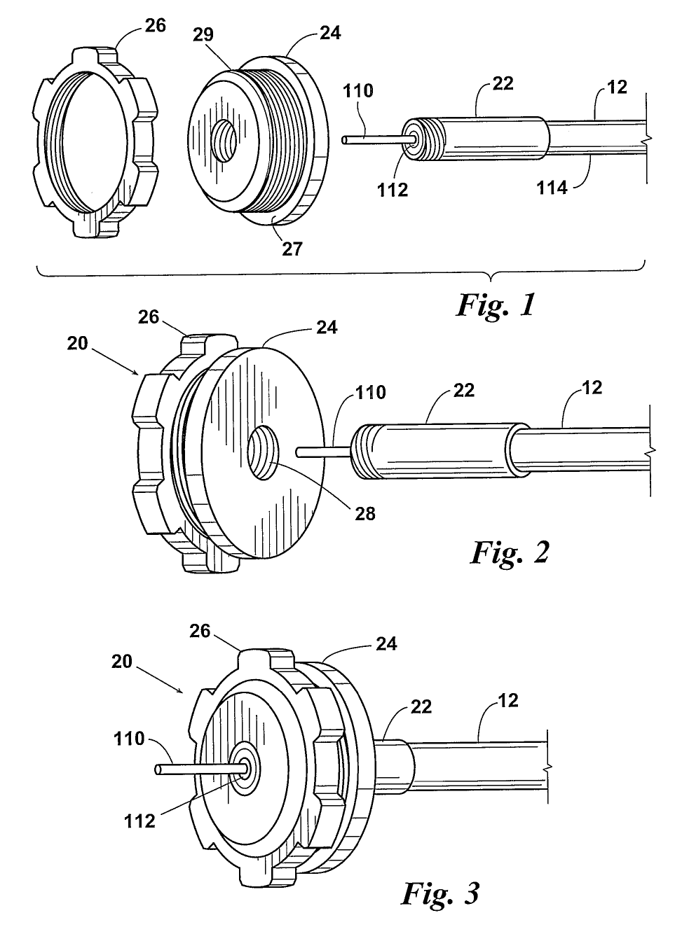

Referring to the drawings and first to FIGS. 1 to 3, a coaxial cable 12 connects to a junction box connector assembly 20 that includes a threaded fitting 22, a threaded bushing 24, and a locknut 26. Coaxial cable 12 is of a type well-known in the art and typically includes a conductor 110, inner insulation 112, a wire mesh (ground), and outside insulation or jacket 114. Threaded fitting 22 may be a crimp fitting, a compression fitting, or a screw-type fitting. An end of coaxial cable 12 receives threaded fitting 22. A threaded central opening 28 in bushing 24 threads onto fitting 22 and allows the conductor 110 and insulation 112 of coaxial cable 12 to pass through the opening 28. Locknut 26 then threads onto an external threaded portion 29 of bushing 24. To maintain the ground connection, a fold-over crimp of the wire mesh is preferred.

In a preferred embodiment, an electrical box (not shown) having either a knockout or fabricated opening receives bushing 24. A flange portion 27 of bushing 24 contacts the exterior surface of the electrical box and locknut 26 threads onto the exposed threads 29 of bushing 24 within the electrical box, thereby providing a ground path and strain relief between coaxial cable 12 and the electrical box. A portion of the shield 112 of coaxial cable 12 may be stripped away so that a required electrical connection can be made.

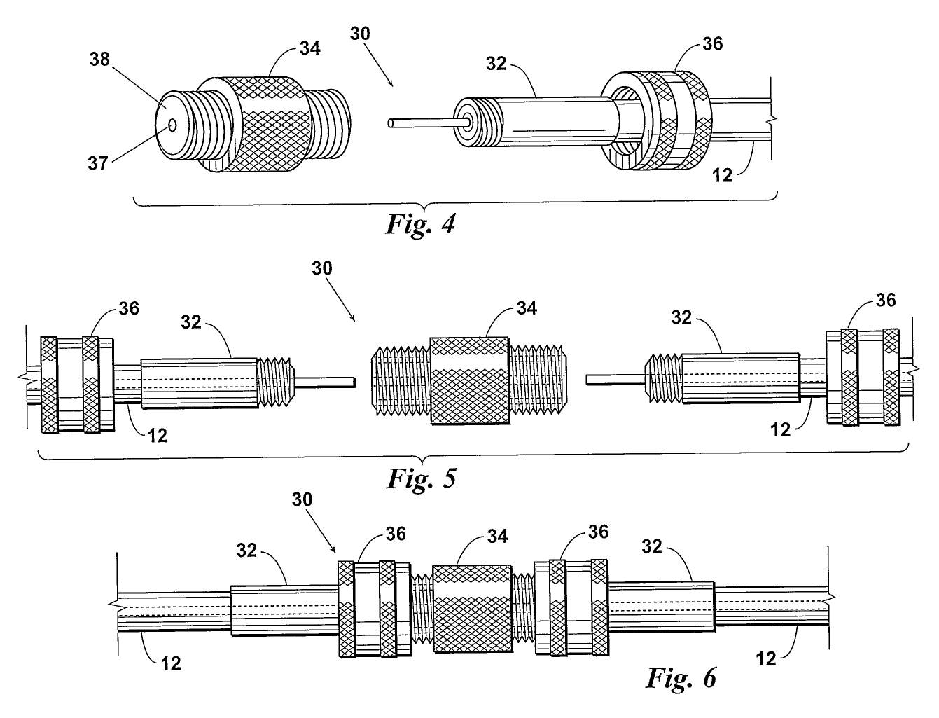

Referring now to FIGS. 4 to 6, coaxial cable 12 connects to a splice assembly 30. Splice assembly 30 includes threaded fitting 32, splice connector 34, and nut 36. Threaded fitting 32 is preferably the same as threaded fitting 22 to provide connectivity to either junction box connector assembly 20 or splice assembly 30. Splice connector 34 contains an insulated conductive bushing 38 with an opening 37 at each end that receives the conductive portion of coaxial cable 12. A reduced inside diameter shoulder portion of nut 36, which is slightly smaller than an outside diameter of the threaded portion of fitting 22, serves to contain nut 36 on coaxial cable 12. Nut 36 then threads onto the exterior threaded portion 39 of splice connector 34 and secures coaxial cable 12, thereby providing a strain relief as well as a ground path. Splice connector 34 may also be configured in a tee-shaped arrangement (not shown) to connect three coaxial cables 12 in the same manner as described above.

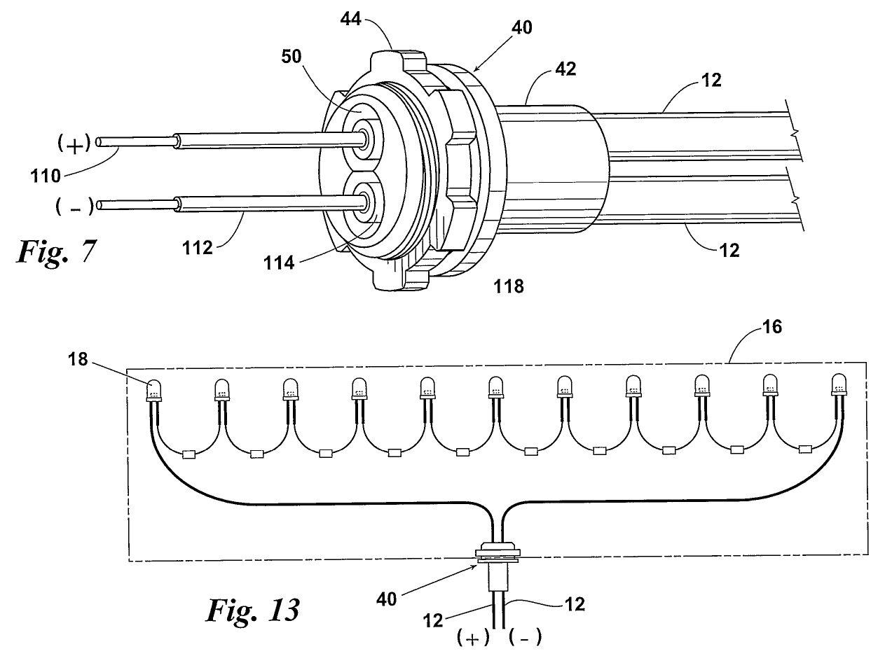

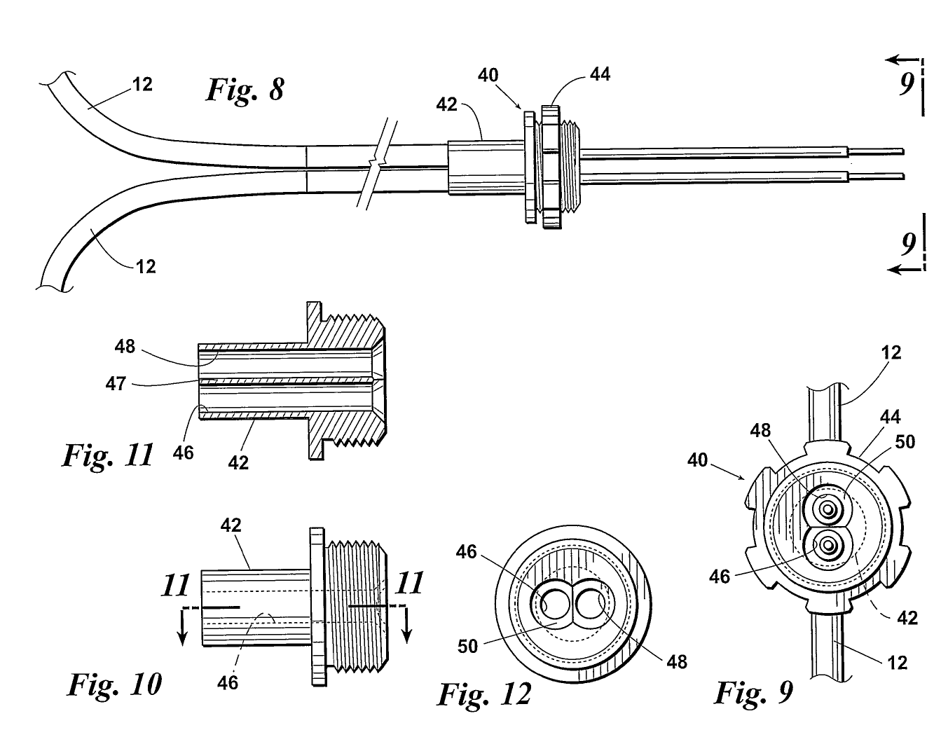

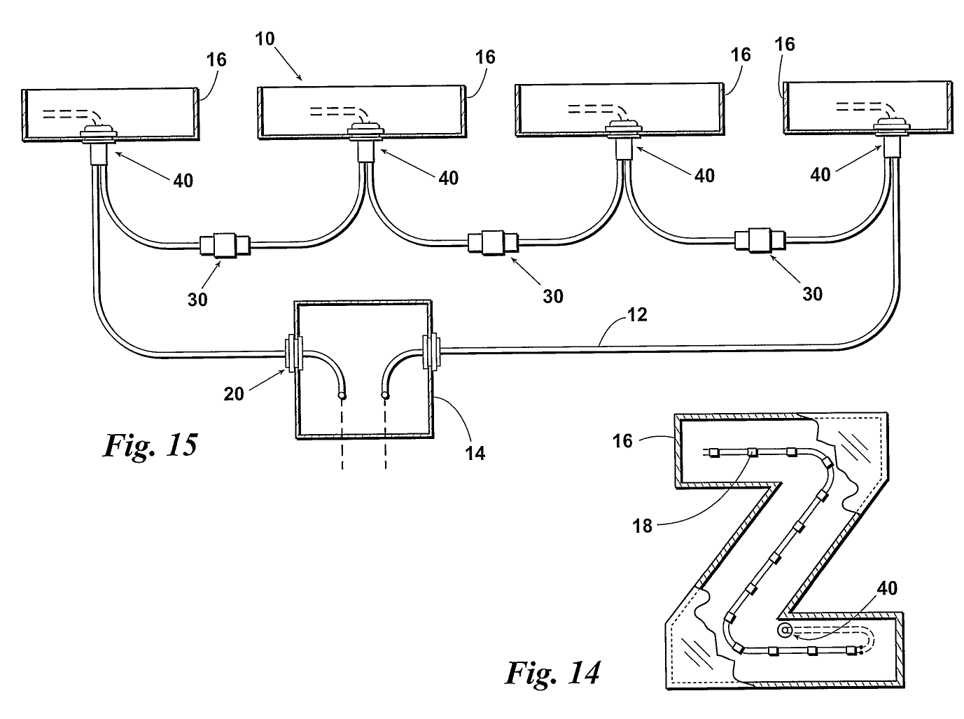

Referring now to FIGS. 7 to 12, two coaxial cables 12 connect to a letter box (see FIGS. 13 and 14) through a dual-cable letter box connector assembly 40. Connector assembly 40 comprises a threaded bushing 42 having two cylindrical, co-planar passageways 46, 48 passing therethrough. The central longitudinal axis of each passageway 46, 48 is preferably substantially parallel to the central longitudinal axis of bushing 42. Each passageway may be separated from the other passageway by an interior wall 47 having a rectangular-shaped cross-section. The inside diameter of each passageway 46, 48 is preferably sized so that a jacketed coaxial cable 12 may pass tightly through each passageway 46, 48. Force is then required to remove cable 12 from the passageway 46, 48. Bushing 42 is preferably sized to be received by the same knockout or opening as that of bushing 24. Locknut 44 is preferably interchangeable with locknut 26. Bushing 42 connects to an electrical box in the same manner as bushing 24 and provides an equipment ground path from coaxial cables 12 and a strain relief pass for the coaxial cables 12.

Referring to FIGS. 13 and 14, in a preferred embodiment connector assembly 40 connects to a letter box 16 that has a knockout or fabricated opening. One of the two coaxial cables 12 provided by connector assembly 40 carries a positive charge and the other carries a negative charge. Letter box 16 is of a type well-known in the art and may comprise any number of geometrical configurations typically found in commercial signage. One or more light emitting diodes (LEDs) 18 are arranged within an interior space of letter box 16 to produce a predetermined letter, symbol, image, or word. Because of their low current draw, the LEDs 18 may be arranged in series without an observer perceiving any loss in lighting intensity across the series. The conductive portion 110 of each coaxial cable 12 is then placed in communication with the LEDs 18 to provide sufficient current to light the LEDs 18.

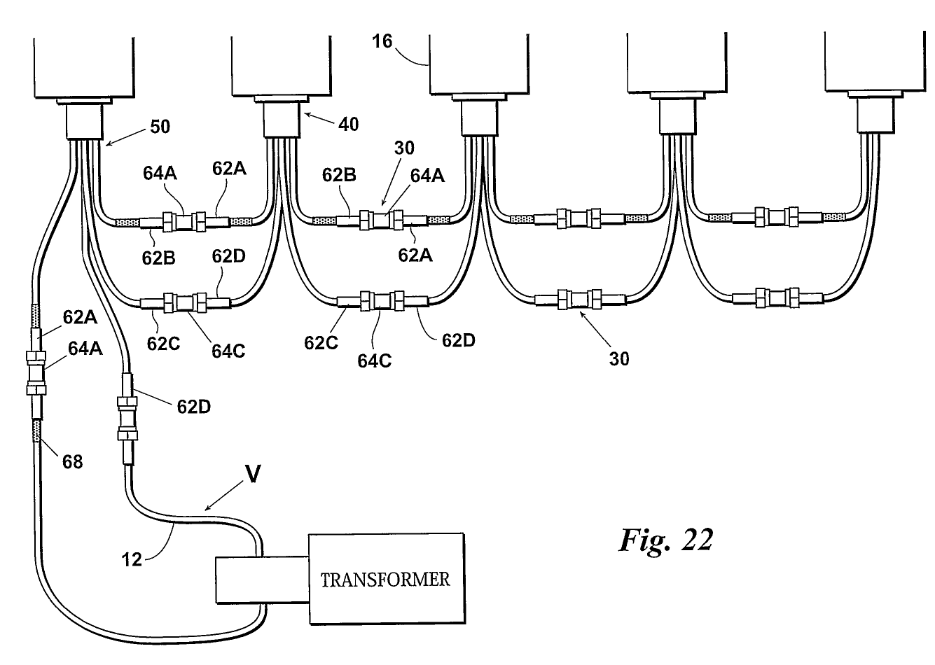

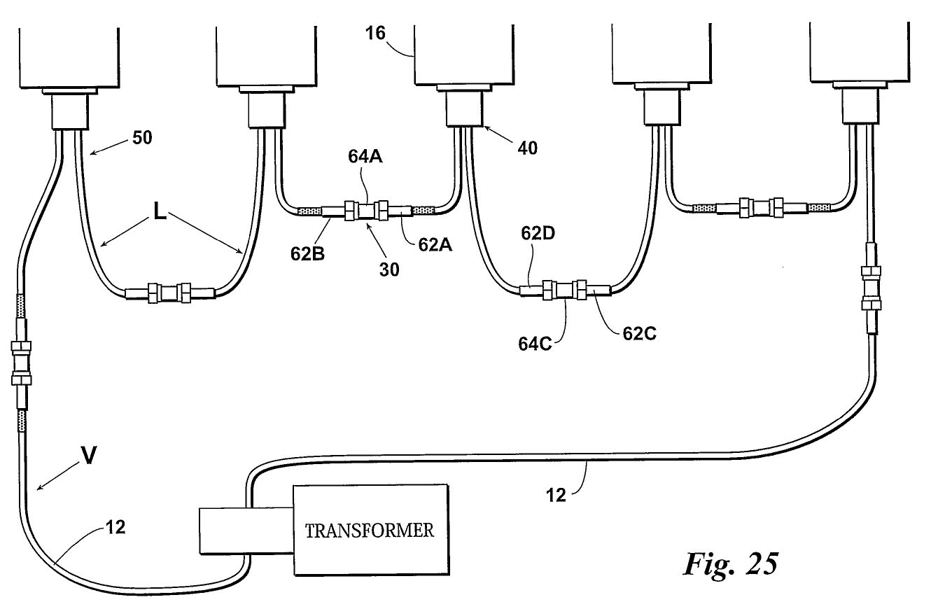

Referring now to FIG. 15, wiring system 10 may include different arrangements of junction box connector assemblies 20 and 40 and splice assemblies 30. Connector assembly 30 provides coaxial cable 12 to a junction box 14 and a power supply (see FIGS. 22 and 25). The power supply is preferably less than a 50V AC or DC power supply. Connector assembly 40 provides coaxial cable 12 to the letter boxes 16. System 10 supplies a complete wiring system that maintains mechanical and electrical protection without the use of standard conduit and electrical fittings. In addition, the unique configuration of connector assemblies 20 and 40 allows an installer to drill a smaller hole through the letter box 16 or other attachment holding the LED 18 than the hole required by standard conduit or electrical fittings.

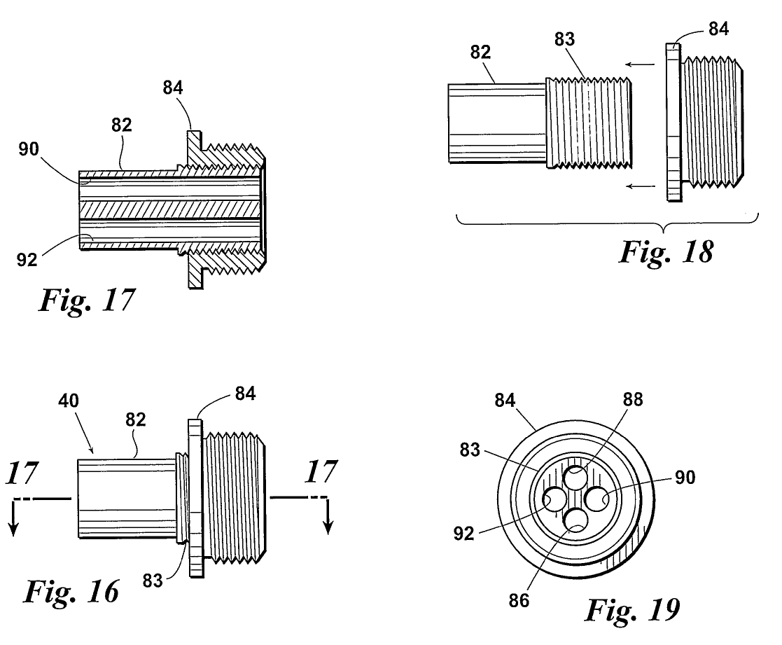

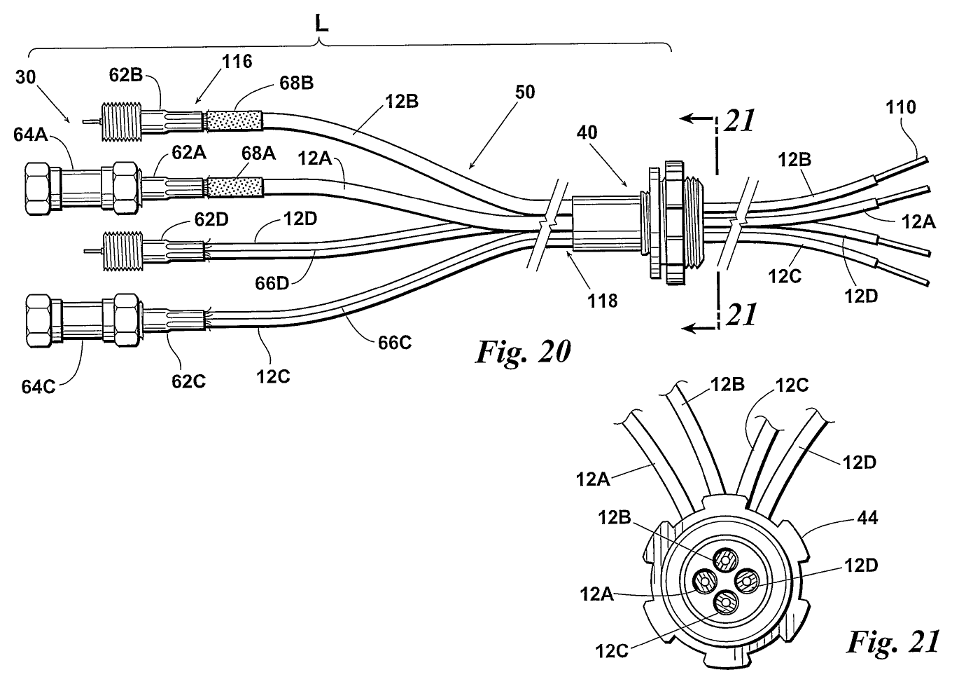

Referring now to FIGS. 16 to 19, an alternate embodiment of letter box connector 40 is illustrated. Similar to bushing 42 (see FIG. 7), bushing 82 is located at a second end 118 of cable 12 (see FIG. 20). Bushing 82 has an external threaded portion 83 that is received by and threads into threaded fitting 84. Bushing 82 has cylindrical passageways 86, 88, 90 and 92. The central longitudinal axis of each passageway 86, 88, 90 and 92 is preferably substantially parallel to the central longitudinal axis of bushing 82.

The inside diameter of each passageway 86, 88, 90, 92 is preferably sized so that a portion of jacketed coaxial cable 12 may pass tightly through each passageway 86, 88, 90, 92. In other words, the second end 118 of each cable 12 is received by the respective passageway 86, 88, 90, 92 and then passes through the respective passageway so that a portion of the coaxial cable 12 residing between the first end 116 and second end 118 is tightly held by the respective passageway. Force is then required to remove cable 12 from each passageway 86, 88, 90, 92. A locknut 44 (see FIG. 21) threads onto the threaded portion 84 and secures the connector assembly 40 to the letter box 16, thereby providing a ground path and strain relief between coaxial cable 12 and the letter box 16.

Junction box connector 20 may also be similarly constructed using bushing 82 with one passageway 86, two passageways 86, 88, or four passageways 86, 88, 90 and 92 with all of the passageways being used or one or more of the passageways being unused.

FIGS. 20 to 22 illustrate fitting 40 as part of a wiring set 70 configured for a parallel wiring arrangement. Four coaxial cables 12A-D pass through fitting 40. Wiring set 70 is preferably preassembled and delivered to the job site with each cable 12 being a predetermined length L, preferably 3 feet in length. Splice assembly 30 includes a threaded fitting 62 and a nut 64 that threads onto fitting 62. Coaxial cables 12 are preferably color coded with a marking 66, such as a line drawn on the outer surface of outer insulator 114, or band 68 to ensure proper polarity connections to an opposing set of cables (see FIG. 22). Marking 66 or band 68 may be color-coded. A variable length run of cable 12 connects the first wiring set 70 to a transformer.

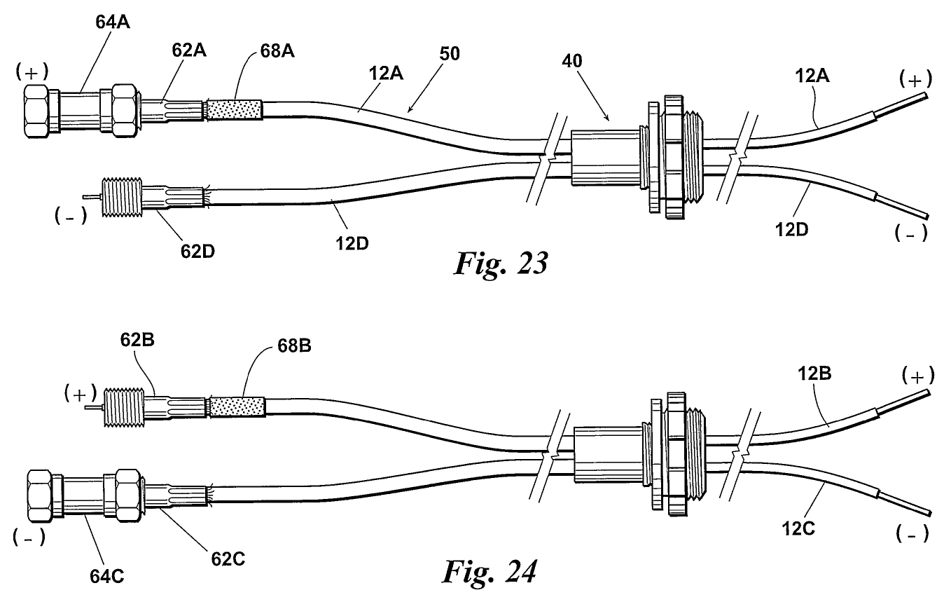

FIGS. 23 to 25 illustrate fitting 40 as part of a wiring set 70 that is configured for a series wiring arrangement. Two coaxial cables 12A-D, again preferably of a predetermined length L, pass through fitting 40. Fitting 40 may have two passageways 86 and 88 or four passageways 86, 88, 90 and 92 (with two of the four passageways unused). Coaxial cables 12A and 12C may be spliced together by connecting connector 62A to nut 64C of coaxial cable 12C. Similarly, cables 12B and 12D may be spliced together by connecting nut 64B to connector 62D. Color bands 68B and 68D help ensure the proper polarity connections. A variable length run V of cable 12 connects the first and last wiring set 70 to a transformer.

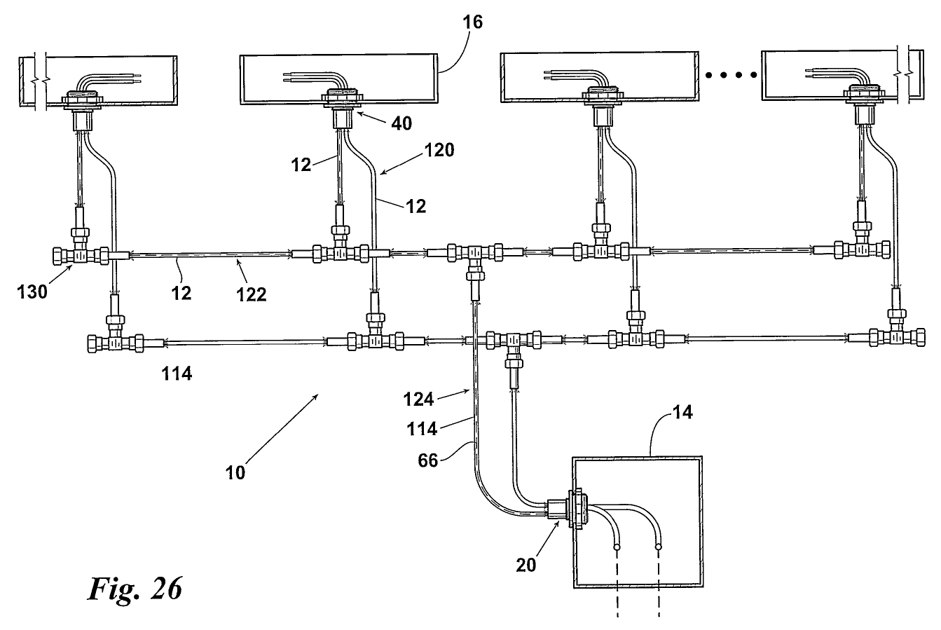

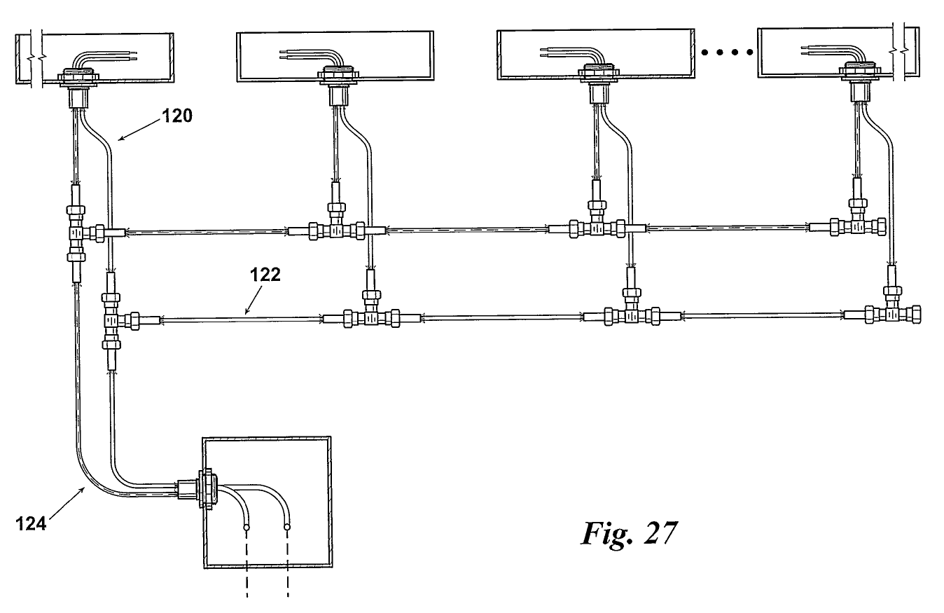

FIGS. 26 and 27 illustrate a 2-wire wiring system 10 arranged in a split parallel and a standard parallel wiring arrangement, respectively. (Wiring system 10 may also be wired according to a serial wiring arrangement but a parallel wiring arrangement is preferred because it is easier to troubleshoot.) Wiring system 10 ensures safe, correct and proper wiring installation by providing the proper conductor to move 5 amps, a safety ground path, and visual cues that ensure red-to-red and black-to-black wiring connections throughout. Each wiring system 10 includes, for a specified signage application, the required number of pass-thru or letter box leads 120 and jumper leads 122, and a transformer lead 124.

Letter box lead 120 includes a letter box assembly connector 40 and a pair of coaxial cables 12. Jumper lead 122 includes a coaxial cable 12 with a threaded fitting 62 at one end and a splice assembly connector 130 at the other end. Two jumper leads 122 may be secured to one another by way of a cable tie in order provide a pair of jumper leads 122. Transformer lead 124 includes a junction box assembly connector 20 and two coaxial cables 12 each having a splice assembly connector 130 at one end. The leads 120, 122, and 124 are preferably color-coded to indicate polarity. In a preferred embodiment, splice connector assembly 130 is a 3-way splice connector with no resistor. The coaxial cables 12 of leads 120, 122 and 124 may include a colored jacket 114 with appropriate color markings 66 on one or both cables 12 to indicate polarity and ensure red-to-red and black-to-black connections throughout wiring system 10.

While a wiring system for LED signs has been described with a certain degree of particularity, many changes may be made in the details of construction and the arrangement of components without departing from the spirit and scope of this disclosure. The wiring system, therefore, is not limited to the embodiments set forth herein for purposes of exemplification, but is to be limited only by the scope of the attached claim or claims, including the full range of equivalency to which each element thereof is entitled.

What is claimed is:

1. A wiring set comprising:
a bushing being connectable to an opening in one of a letter box housing and a junction box and having at least two substantially cylindrical longitudinal passageways therethrough; and
at least two coaxial cables having a first end and a second end, each said first end having a threaded fitting, each said second end being received by a respective said passageway;
a portion of each said coaxial cable between said first and second end being tightly contained within said passageway.

2. A wiring set according to claim 1 each said passageway having a chamfered opening at an end of said passageway.

3. A wiring set according to claim 1 further comprising a splice assembly connector connectable to said threaded fitting.

4. A wiring set according to claim 3, said splice assembly connector is a three-way splice assembly connector.

5. A wiring set according to claim 3 further comprising said splice assembly connector having an external threaded portion, a bushing with an opening at each end for receiving a conductive portion of a coaxial cable, and a nut.

6. A wiring set according to claim 1 further comprising said threaded fitting being one of a crimp fitting, a compression fitting, and a screw-type fitting.

7. A wiring set according to claim 1 further comprising a length of said at least two coaxial cables being a predetermined length “L”.

8. A wiring set according to claim 1 further comprising at least one of said coaxial cables having at least one of a marking and a band indicating a proper polarity connection with an opposing coaxial cable of a second wiring set.

9. A wiring system for LED signs comprising:
at least two coaxial cables, each said coaxial cable having a first end and a second end and arranged in a circuit relationship to a power supply and at least one light emitting diode, said light emitting diode being located within a letter box housing; and
a bushing connectable to said letter box housing, said bushing having at least two substantially cylindrical longitudinal passageways therethrough, each said passageway capable of receiving and holding a portion of a respective said coaxial cable between said first and second end.

10. A wiring system according to claim 9 further comprising said first end having a threaded fitting.

11. A wiring system according to claim 10 further comprising a splice connector assembly connectable to said threaded fitting of a first coaxial cable and said threaded fitting of an opposing coaxial cable.

12. A wiring set according to claim 9 further comprising at least one of said coaxial cables having one of a marking and a band indicating a proper splice connection with an opposing coaxial cable.

13. A wiring system according to claim 9 further comprising a length of said at least two coaxial cables is a predetermined length “L”.

14. A wiring system according to claim 9 further comprising a power supply, said power supply is in a range of 50V or less.

15. A method of wiring a light emitting diode sign, said method comprising the steps of:
connecting a conductive portion of a first end of a length of first coaxial cable to a power supply;
splicing a second end of the first coaxial cable to a first end of a second coaxial cable, a portion of the second coaxial cable passing tightly through a passageway in a first bushing connectable to a letter box housing;
securing the bushing to the letter box housing;
connecting a conductive portion at a second end of the second coaxial cable to a light emitting diode housed within the letter box housing; and
providing a safety ground path.

16. A method according to claim 15 further comprising splicing a first end of a third coaxial cable that passes tightly through a second passageway of the first bushing to a first end of a fourth coaxial cable that passes tightly through a passageway in a second bushing connectable to a second letter box housing.

17. A method of wiring a light emitting diode sign, said method comprising the steps of:
connecting a letter box lead to a letter box; and
connecting a transformer lead to the letter box lead;
wherein the letter box lead and the transformer lead each include at least two coaxial cables and a bushing, a portion of the coaxial cables passing tightly through the bushing, the bushing providing a safety ground path for the respective lead.

18. A method according to claim 17 further comprising the step of connecting a jumper lead to an adjacent pair of letter box leads, wherein the jumper lead includes at least two coaxial cables and a splice assembly.

19. A method according to claim 18 further comprising the step of assembling the letter box lead, the transformer lead, and the jumper lead into a set of leads appropriate for a light emitting diode signage application.
